(19) United States
(12) Patent Application Publication
(10) Pub. No.: US 2025/0115343 A1
(43) Pub. Date: Apr. 10, 2025

(54) Environmentally-Friendly Ship Propulsion System

(71) Applicants: Gabriel BAKKERS, Zofingen (CH); Abdul Rahman AL KHABBAZ, Wynau (CH); Jürg André HOSTETTLER, Huttwil (CH)

(72) Inventors: Gabriel BAKKERS, Zofingen (CH); Abdul Rahman AL KHABBAZ, Wynau (CH); Jürg André HOSTETTLER, Huttwil (CH)

(21) Appl. No.: 18/578,378

(22) PCT Filed: Jul. 13, 2022
(86) PCT No.: PCT/IB2022/056452

§ 371 Date: Jan. 11, 2024

(30) Foreign Application Priority Data
Jul. 15, 2021 (EP) 21185936.8

(51) Int. Cl. B63H 19/00; B63J 1/00

(52) U.S. Cl. CPC B63H 19/00; B63J 1/00

(57) ABSTRACT

An environmentally friendly ship propulsion system and a method for propelling a ship. The ship propulsion system comprises an osmosis chamber (1), a pressure relief unit (2) and a desalination unit, the osmosis chamber (1) comprising a high salinity region (11) and a low salinity region (12) separated from one another by an osmotic membrane (13). The pressure relief unit (2) having at least one pressure-motion converter connected to the high-salinity region (11) of the osmosis chamber (1) via high-pressure line (21). The desalination unit is suitable for producing salt or at least high-salinity water and fresh water or at least low-salinity water. A fresh water pipe connecting the desalination unit with the low salinity area (12) of the osmosis chamber (1) and a salt water supply (14) is controllably connected to the high salinity area (11) of the osmosis chamber (1). (FIG. 1a)

### BACKGROUND OF THE INVENTION

The present invention relates to an environmentally friendly ship propulsion system according to claim 1 and to a corresponding method for propelling a ship according to claim 8.

Ship propulsion systems traditionally consist of large engines that are usually powered by fossil fuels. As part of efforts to reduce CO2 emissions, more environmentally friendly and sustainable energy sources are now being used. There are some approaches using wind or solar energy to ensure or contribute to the propulsion of ships.

### BRIEF SUMMARY OF THE INVENTION

The object of the present invention is to provide an environmentally friendly ship propulsion system which obtains the energy to propulsion system the ship from an alternative sustainable source.

This object is achieved by an environmentally friendly ship propulsion system with the features of claim 1 and by a corresponding method for propelling a ship with the features of claim 8. Further features and exemplary embodiments are claimed in the dependent claims and their advantages are explained in the following description.

### BRIEF DESCRIPTION OF THE DRAWINGS

The drawings show:

FIG. 1a Osmosis chamber

FIG. 1b Osmotic membrane with ceramic

FIG. 2a Embodiment of the osmosis chamber

FIG. 2b Embodiment of the osmotic membrane with ceramic

FIG. 3a-b Embodiment of the pressure relief unit

FIG. 4a Evaporation chamber

FIG. 4b Misting nozzle

FIG. 5 Overview of the function of an embodiment of the ship propulsion system

The figures represent possible exemplary embodiments, which are explained in the following description.

### DETAILED DESCRIPTION OF THE INVENTION

The core of the invention is a ship propulsion system which obtains energy from osmosis between salt water and fresh water (i.e. water without salt). Cargo ships and tankers operating on the sea have unlimited amounts of water and salt at their disposal, which can be used to propel the ship in an environmentally friendly manner.

In the simplest embodiment of the invention, the ship propulsion system comprises an osmosis chamber 1, a pressure relief unit 2 and a desalination unit.

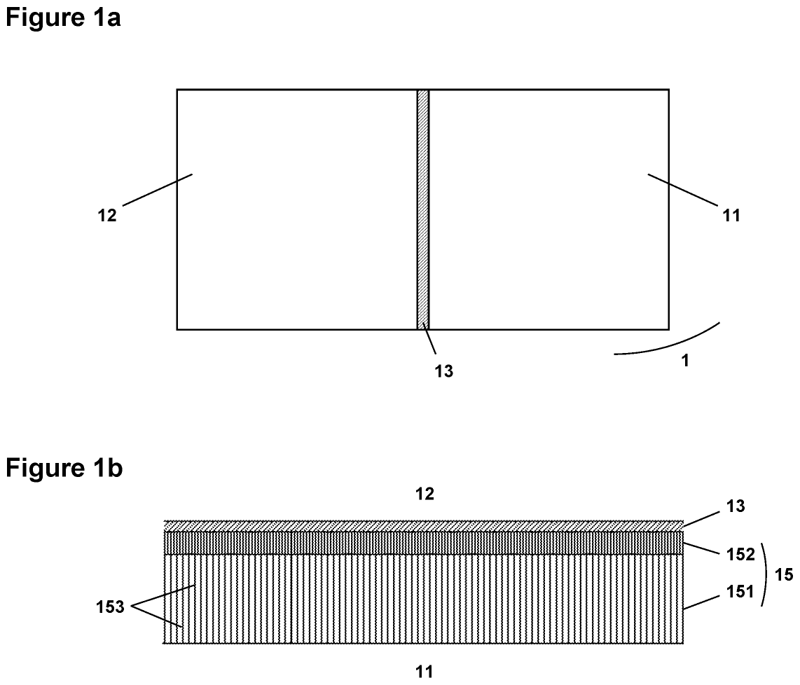

The osmosis chamber 1 comprises a high salinity area 11 and a low salinity area 12, which are separated from one another by an osmotic membrane 13 (FIG. 1a). The high salinity area 11 and the low salinity area 12 are suitable for receiving liquids, in particular water, whose salinity is higher in the high salinity area 11 than in the low salinity area 12. The osmotic membrane 13 is preferably made of polymer and has pores which allow the passage of water between the high salinity area 11 and the low salinity area 12, but not the passage of salt ions dissolved in the water. Due to the different salinity in the high salinity area 11 and in the low salinity area 12, a spontaneous flow of water from the low salinity area 12 to the high salinity area 11 occurs through the osmotic membrane 13 according to the osmosis principle. This process can lead to an overpressure in the high salinity area 11 of up to 500 bar, which is used to propel the ship.

In the preferred embodiment variant of the invention, the osmotic membrane 13 is provided with a porous ceramic 15 on the side of the low salinity area 12 (FIG. 1b). Advantageously, the osmotic membrane 13 is made by applying a coating onto the porous ceramic 15. The porous ceramic fulfils two essential functions. First, due to its stiffness and mechanical strength, the ceramic 15 withstands the high pressure prevailing in the high salinity area 11 and serves as a supporting structure for the osmotic membrane 13. Second, the ceramic 15 promotes the passage of water from the low salinity area 12 to the high salinity area 11. For this purpose, it has continuous capillary channels 153, into which water penetrates due to capillary forces and van der Waals forces and is transported from the low salinity area 12 to the osmotic membrane 13. This creates a suction effect of the water on the surface of the ceramic 15 facing the low salinity area 12 and an increased water pressure at the interface between the ceramic 15 and the osmotic membrane 13, which promote the passage of the water into the high salinity area 11. The porosity of the ceramic 15 can be uniform over the thickness of the ceramic layer 15, with simple capillary channels 153 which open on both sides of the ceramic layer 15, or can vary. For example, each capillary channel extending from the side of the ceramic layer 15 facing the low salinity region 12 to the interface with the osmotic membrane 13 may have one or more branches. Branched capillary channels 153 increase the capillary forces and the water pressure created at the interface to the osmotic membrane 13 and thus promote the passage of the water to the high salinity area 11. The ceramic layer 153 could thus have a first region 151 with a lower density of the capillary channels 153 and a second region 152 with a higher density of the capillary channels 153. Zirconium oxide, iridium oxide or a mixture of both are examples of suitable ceramic materials and have the advantage over metals that they are corrosion-resistant.

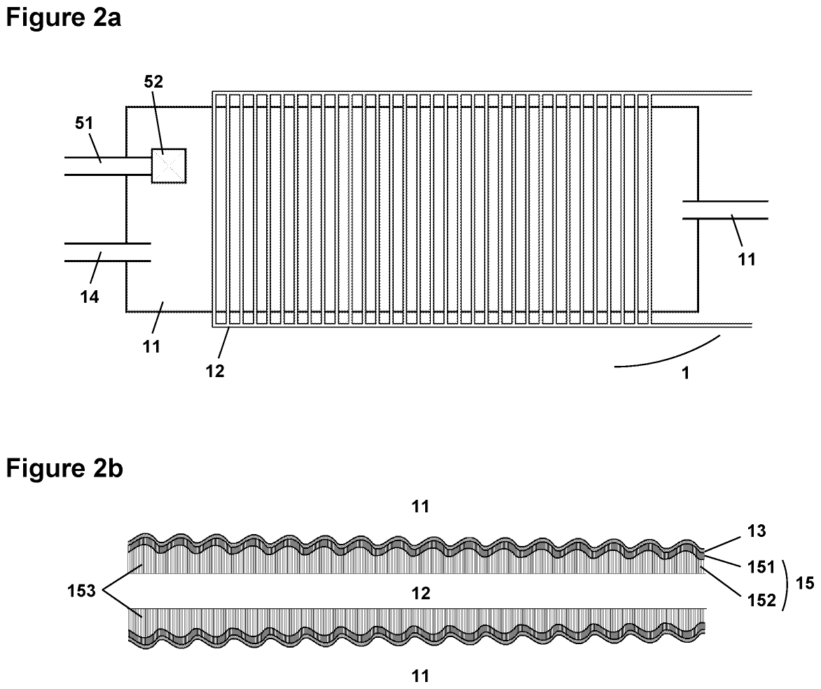

Preferably, the ceramic 15 is in the form of tubes which are coated with the osmotic membrane, and the osmosis chamber 1 is in the form of a tank through which the ceramic tubes pass (FIGS. 2a-b). In this embodiment, the tank forms the high salinity area 11 and the inner volume of the ceramic tubes forms the low salinity area 12. To increase the volume flow through the osmotic membrane 13 and therefore the performance of the osmosis chamber 1, the area of the osmotic membrane 13 and/or the ceramic 15, i.e. the contact area between the high salinity area 11 and the low salinity area 12, can be increased. In advantageous embodiments of the invention, the osmotic membrane 13 and/or the ceramic 15 has a geometry that maximizes its surface area in a given volume. In a possible embodiment, the osmotic membrane 13 and the ceramic 15 are not flat, but have a large number of elevations and depressions; for example, the ceramic tube 15 can have a corrugated outer surface (FIG. 2b).

The pressure relief unit 2 is adapted for converting the excess pressure prevailing in the high salinity area 11 into mechanical energy for driving the ship, for example with a ship's propeller, and has at least one pressure-motion converter for this purpose, for example a piston. A high-pressure line 21 leads pressurized water from the high salinity region 11 of the osmosis chamber 1 to the pressure-motion converter of the pressure relief unit 2. After passing through the pressure relief unit 2, the used water is completely or partially led to the desalination unit via a salt water supply line 31. The remaining water that is not led to the desalination unit can be released into the environment through a drain 22. This does not pose pollution problems as it is merely salt water with no additives or chemical pollutants.

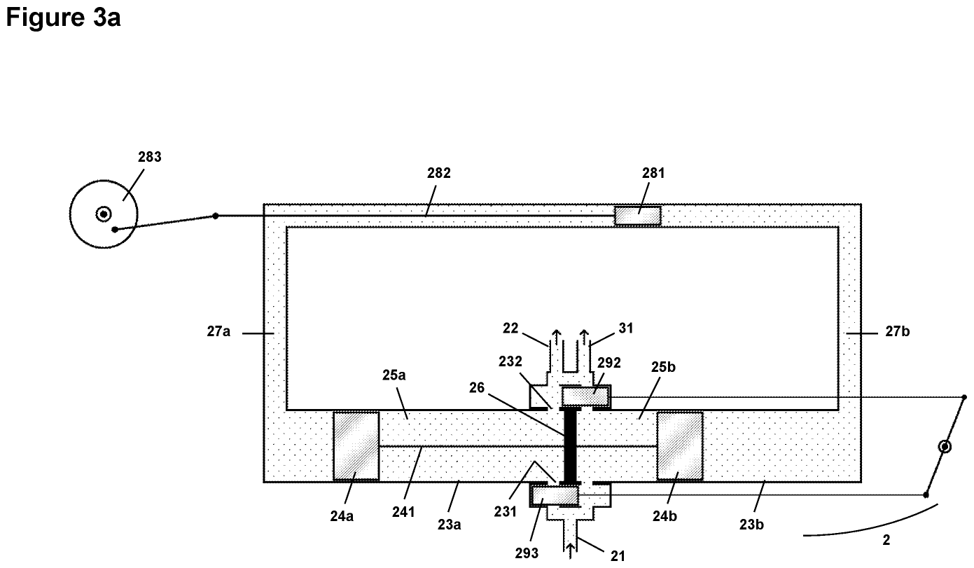

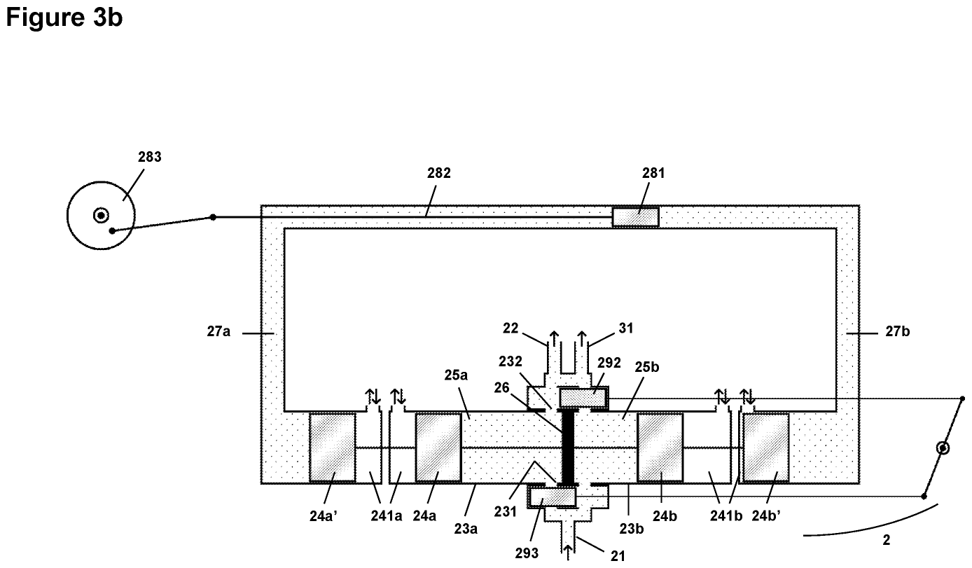

In a possible embodiment of the invention, the pressure relief unit 2 has two cylinders 23a, 23b, each with a first piston 24a, 24b, which are arranged along the same longitudinal axis (FIG. 3a). The two first pistons 24a, 24b are connected to one another, for example by one or more rods 241, so that they move together and are always at the same distance from one another. The area of each cylinder facing the other cylinder 23a, 23b forms a front chamber 25a, 25b, which is delimited by the first piston 24a, 24b, the lateral walls of the cylinder 23a, 23b and an immovable end wall 26 of the cylinder 23a, 23b. The internal volume of each front chamber 25a, 25b decreases when the first piston 24a, 24b is moved toward the end wall 26 of the cylinder 23a, 23b, and increases when the first piston 24a, 24b moves away from the end wall 26 of the cylinder 23a, 23b. On the other side of each cylinder 23a, 23b there is a rear chamber 27a, 27b which contains a liquid, for example water or oil. Each rear chamber 27a, 27b is delimited by the first piston 24a, 24b, by lateral walls and by an end face of a second piston 281. A single second piston 281 is provided for both rear chambers 27a, 27b, with one end of the second piston 281 facing the first front chamber 27a and the opposite end of the second piston 281 facing the second front chamber 27a. The internal volume of each rear chamber 27a, 27b between each first piston 24a, 24b and the second piston 281 is constant, so that movement of the first pistons 24a, 24b at one end of the two rear chambers 27a, 27b causes a corresponding movement of the second piston 281 at other end of the rear chambers 27a, 27b. This second piston 281 is connected by a connecting rod 282 to a crankshaft 283, which is used to propel the ship. The rear chambers 27a, 27b are preferably spatially separated from the front chambers 25a, 25b, for example in that each piston 24a, 24b consists of two piston parts 24a, 24a′, respectively 24b, 24b′, which are connected to one another by one or more rods (FIG. 3b). This is particularly advantageous when using hydraulic oil so that fluid creep can be controlled (i.e. mixing of the hydraulic oil with the salt water is avoided). Between the two piston parts 24a, 24a′, respectively 24b, 24b′ there are spatially separate intermediate chambers 241a, 241b into and out of which fluids, for example air, can flow freely in order not to hinder the movement of the piston parts 24a, 24a′, respectively 24b, 24b′.

Each front chamber has at least one inlet 231 and one outlet 232, the inlets 231 being connected to the high pressure line 21 and the outlets 232 being connected to the salt water supply line 31 and optionally to the drain 22. The pressurized water of the high-pressure line 21 is guided by an inlet control either into the front chamber 25a of a cylinder 23a or into the front chamber 25b of the other cylinder 23b by opening or sealing the inlet 231. This can be achieved, for example, by an intake valve 293 movable between two positions: a first position in which the inlet 231 of the a cylinder 23a is tightly closed and the inlet 231 of the other cylinder 23b is open, and a second position in which the inlet 231 of a cylinder 23a is open and the inlet 231 of the other cylinder 23b is tightly closed. The same applies to the outlets 232, with an outlet control allowing the exit of water from either of the front chambers 25a, 25b by opening or tightly closing the outlet 232 of a cylinder 23a or of the other cylinder 23b. This can be achieved, for example, by an outlet valve 292, which functions similarly to the inlet valve 293. It is important that the outlet 232 of a front chamber 25a, 25b is always tightly closed when the inlet 231 of the same front chamber 25a, 25b is opened. Then, the pressurized water of the high-pressure line 21 flows into this front chamber 25a, 25b and pushes the corresponding first piston 24a, 24b away from the end wall 26 of the cylinder 23a, 23b. This movement of the first piston 24a, 24b is transmitted to the second piston 281 and then to the connecting rod 282 by the liquid located in the rear chamber 27a, 27b. Since both first pistons 24a, 24b are connected to each other, the first piston 24a, 24b of the other cylinder 23a, 23b is simultaneously moved towards the end wall 26 of the cylinder, and the water in the corresponding front chamber 25a, 25b is passed through the salt water pipe 31 and optionally also pushed out of it through the drain 22. Each front chamber 25a, 25b is emptied before it is filled again in the next cycle with the pressurized water from the pressure line 21. At the beginning of the next cycle, the position of the inlet and outlet valves 292, 293 is switched.

Osmosis is a slow process, so that depending on the specific design of the pressure relief unit 2, the movement of the first pistons 24a, 24b could be too slow for direct propulsion of the ship. To remedy this, the second piston 281 advantageously has a smaller diameter than the two first pistons, so that a certain movement of the first larger pistons 24a, 24b causes a faster movement of the second smaller piston 281. Additionally or alternatively, several osmosis chambers could also be connected to a pressure-motion converter in order to accelerate it.

The ship propulsion system according to the invention can comprise a single osmosis chamber 1 or several osmosis chambers 1. Each osmosis chamber 1 can be relatively small, with a volume of e.g. 100 litres, and several osmosis chambers 1 can be combined by parallel or series connection to obtain the desired pressure and speed. The ship propulsion system can also include a single or multiple pressure relief units 2, with all pressure relief units 2 being connected to a single osmosis chamber 1, or each pressure relief unit 2 being connected to its own separate osmosis chamber 1, or several osmosis chambers 1 being connected to a pressure-motion converter.

The desalination unit is suitable for separating salt and water, whereby on the one hand salt or at least high-salinity water and on the other hand fresh water or at least low-salinity water are obtained. A salt water supply line 31 directs the salt water used by the pressure relief unit 2 to the desalination unit. Additionally or alternatively, salt water could also be led directly from the environment (i.e. sea water if the ship is sailing on the sea) to the desalination unit. The salt water is desalinated into the desalination unit by distillation and/or by electrodialysis.

In the embodiment of the desalination unit with distillation, the desalination unit comprises an evaporation chamber 32, a condensation chamber and a heater which provides the salt water with the thermal energy required for evaporation. The salt water is heated by heating with solar energy, for example by passing it directly through hot water solar collectors or through a heat exchanger, in which case another suitable heat transfer fluid is passed through solar collectors. The heating can also be electric and be operated with electrical energy from photovoltaic solar cells or wind turbines. Typical cargo ships and tankers are several hundred meters long and tens of meters wide, leaving considerable space available for solar panels and solar cells. Wind turbines are particularly beneficial when the weather is too cloudy to generate enough solar energy. For better evaporation of the salt water, the desalination unit also has atomization nozzles 321 in the evaporation chamber 32. They atomize the heated salt water into small droplets, which multiplies the contact area between the salt water and the internal atmosphere of the desalination unit and accordingly promotes the evaporation of the salt water. The evaporated water is then led from the evaporation chamber 32 to the condensation chamber, in which it is condensed as fresh water, while all non-volatile elements such as salt accumulate on the bottom of the evaporation chamber 32. Advantageously, the inner walls of the evaporation chamber 32 are as smooth as possible and consist of or are coated with a material to which salt crystals adhere little. This avoids excessive crystal formation on the inner walls of the evaporation chamber 32 and ensures that all of the salt falls to the bottom of the evaporation chamber 32 and can be easily collected there. Suitable materials are e.g. PEEK (polyetheretherketone) or a high-performance ceramic coated with titanium. The distillation of the salt water produces salt on the one hand and fresh water on the other.

It is particularly advantageous if the condensation chamber is designed as a heat exchanger in which the thermal energy of the incoming water steam and the warm condensed fresh water (as soon as the water steam has fallen below 100° C.) is transferred to the salt water entering the desalination unit. Designing the condensation chamber as a heat exchanger enables considerable energy savings, since the energy for heating the salt water entering the desalination unit is largely obtained from the water exiting the desalination unit. The fresh water generated is then fed via a fresh water pipe into the low salinity area 12 of the osmosis chamber 1, from which it spontaneously flows back into the high salinity area 11 through osmosis.

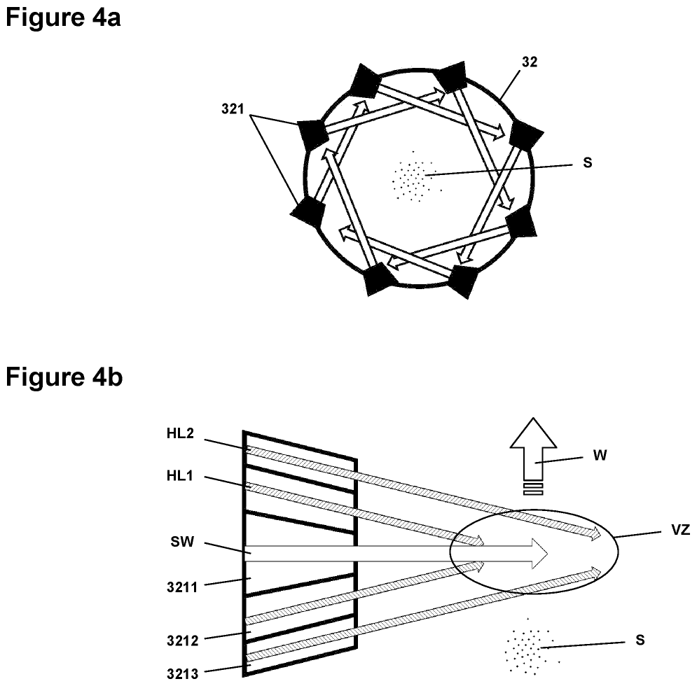

In an advantageous embodiment, the evaporation chamber 32 is essentially cylindrical and comprises a plurality of misting nozzles 321, which are arranged in such a way that they generate a vortex in the evaporation chamber 32 (FIG. 4a). For example, a plurality of misting nozzles 321 can be arranged on the inner walls of the evaporation chamber 32 and aligned at an angle between the radial and tangential directions, for example 45° to the radial direction. Due to the vortex generated in the evaporation chamber 32, the falling salt crystals S are limited in the central region of the evaporation chamber 32 and do not accumulate on its inner walls. This also ensures that the atmosphere and droplets within are constantly circulated, improving the evaporation of the salt water. It is also particularly advantageous if the misting nozzles 321 include a central salt water channel 3211 for salt water SW, a first concentric air channel 3212 for hot air HL1 and a second concentric air channel 3213 for hot air HL2. The middle salt water channel 3211 forms the longitudinal central axis of the misting nozzle 321 and is surrounded by the first concentric air channel 3212, which itself is surrounded by the second concentric air channel 3212. The concentric air channels 3212, 3213 are frustoconical and converge to the longitudinal central axis of the misting nozzle 321, so that salt water SW emerging from the middle salt water channel 3211 on the front of the misting nozzle 321 first crosses the hot air flow HL1 emerging from the first concentric air channel 3212, and then the hot air flow HL2 emerging from the second concentric air channel 3212. The salt water SW is surrounded by the hot air streams HL1, HL2 in a nebulization cell VZ of hot air, which ensures rapid evaporation of the salt water SW shortly after it emerges from the nebulizer nozzle 321 and a rapid separation of water W and salt Z. Particularly efficient evaporation is achieved when the salt water SW in front of or in the salt water channel 3211 is heated to a temperature higher than 90° C. and the hot air HL1, HL2 in the concentric air channels 3211, 3212 is heated to temperatures higher than 108° C., wherein the temperature of the air in the second concentric air channel 3212 is higher than that in the first concentric air channel 3211.

In a specific embodiment of the desalination unit with distillation, the excess steam pressure that arises in the evaporation chamber 32 due to the evaporation of the salt water is used to generate electricity. For this purpose, at least one steam turbine 6 is provided, which is arranged, for example, between the evaporation chamber 32 and the condensation chamber 33. In addition, part of the steam generated in the evaporation chamber 32 could also reach the condensation chamber 33 directly and the remaining part of the steam water could be led to the steam turbine 6 and then released into the environment.

In the embodiment of the desalination unit with electrodialysis, the desalination unit has an electrodialysis separator that is operated with solar energy from photovoltaic solar cells. The electrodialysis separator cannot completely separate salt and water and therefore produces high-salinity water on the one hand and low-salinity water on the other hand from the incoming salt water. The generated low salinity water is then passed via a fresh water pipe into the low salinity area 12 of the osmosis chamber 1, from which it spontaneously passes into the high salinity area 11 through osmosis. The desalination unit does not necessarily have to produce fresh water which is completely free of salt ions. The only decisive factor for osmosis is that the salinity of the low salinity water is significantly lower than the salinity of the water in the high salinity range 11. However, experiments have shown that when using low salinity water, there is a risk of the osmotic membrane becoming blocked by salt ions.

In the preferred embodiment of the desalination unit, no electrodialysis separator is used alone, but it is rather switched, for example, in front of an evaporation chamber 32 and serves for the preliminary partial separation of salt and water.

Salt water is extracted from the environment (i.e. sea water when the ship is travelling on the sea) and enters the high salinity area 11 of the osmosis chamber 1 through a salt water supply 14. To control the ship's propulsion, the salt water supply 14 is controllably connected to the high salinity area 11 and can be opened and closed to a greater or lesser extent. For optimal mixing of the salt water in the osmosis chamber 1, it is advantageous if salt water is introduced on several sides of the osmosis chamber 1, i.e. the salt water supply 14 can have several outlets at various points in the osmosis chamber 1. It is also advantageous if a pressurization unit 4 is provided for injecting the salt water into the high salinity area 11, which sucks in the salt water from the environment and puts it under the same pressure prevailing in the high salinity area 11. It is particularly advantageous if the pressurization unit 4 is mechanically connected to the pressure relief unit 2 in such a way that part of the pressure energy of the water emerging from the high salinity area 11 is reused for pressurizing the salt water entering the high salinity area 11.

The gross power L_{gross} of the pressure relief unit 2 is proportional to the product between the pressure D and the volume flow V₃ of the water emerging from the high salinity area 11 (L_{gross}α(D·V₃). From this gross power L_{gross}, a pressurization power L_{DBA} is used up, which is proportional to the product between the pressure D and the volume flow V₁ of the salt water (L_{DBA}∝D·V₁) injected into the high salinity area 11. The remaining net power Lₙₑₜ of the pressure relief unit 2 available to propel the ship is therefore: Lₙₑₜ=L_{gross}−L_{DBA}, i.e. Lₙₑₜ∝D(V₃−V₁). The volume flow V₃ of the water emerging from the high salinity area 11 is the sum of the volume flow V₁ of the salt water injected into the high salinity area 11 and the volume flow V₂ of the fresh water of the low salinity area 12 spontaneously penetrating through the osmotic membrane 13 (V₃=V₁+V₂). The net power Lₙₑₜ of the pressure relief unit 2 is therefore proportional to the product between the pressure D and the volume flow V₂ of the fresh water penetrating through the osmotic membrane 13: Lₙₑₜ∝D(V₃−V₁)∝D·V₂. According to the osmosis principle, both the pressure D in the high salinity area 11 of the osmosis chamber 1 and the volume flow V₂ through the osmotic membrane 13 are increasing functions of the difference between the salinity of the water in the high salinity area 11 and the salinity of the water in the low salinity area 12. For optimal performance of the pressure relief unit 2, the salinity of the water in the high salinity area 11 should be as high as possible and the salinity of the water in the low salinity area 12 should be as low as possible. If fresh water (zero salinity) comes from the desalination unit into the low salinity area 12 of the osmosis chamber 1, the salinity of the fresh water cannot be reduced further. However, the salinity of the water in the high salinity area 11 can be increased, in extreme cases up to saturation. In an advantageous embodiment of the invention, the salinity of the salt water injected into the high salinity area 11 is additionally increased with the salt or high salinity water generated by the desalination unit. For this purpose, a salt reuse unit is provided, which collects the salt from the evaporation chamber 32 or the high salinity water from the electrodialysis separator and transports it to a salt mixer 52 via a salt feed 51. The salt mixer 52 is used to add the salt or high salinity water into the water, which is either already in the high salinity area 11 of the osmosis chamber 1, or is injected into the high salinity area 11 (FIG. 2a). The salt mixer 52 can also be arranged in the salt water supply 14, for example. It is advantageous if salt is introduced in the form of supersaturated salt water, i.e. in the form of salt water containing solid salt crystals.

According to the present invention, the propulsion power of the ship is produced by the osmosis chamber, which consumes salt or high-salinity water and fresh water or low-salinity water as fuel. The supply of salt or high-salinity water and fresh water or low-salinity water is constantly renewed using solar energy from the surrounding area. However, this assumes sunny times. For starting the ship and for long periods without sun (e.g. by night), it is therefore an advantage if a supplementary energy source is available. It is particularly advantageous if the ship propulsion system according to the invention also includes a hydrogen propulsion system, which can generate a driving force from hydrogen. The hydrogen required for this is stored in a hydrogen tank. It is preferred if there is also a hydrogen generator with which hydrogen can be produced by electrolysis of water. The hydrogen can be generated using solar energy from photovoltaic solar cells during sunny periods and stored in the hydrogen tank for later consumption.

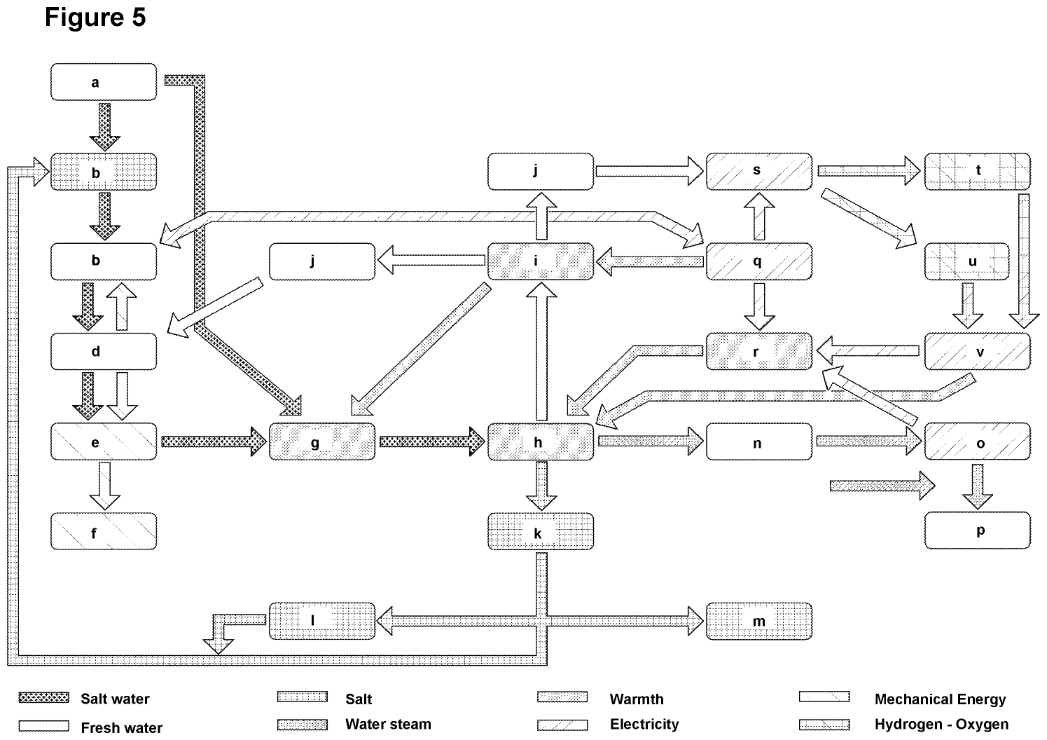

FIG. 5 summarizes the most important features of the ship propulsion system described:
a) Ingress of seawater, e.g. by taking advantage of the ship's water displacement;
b) Optional addition of salt to the incoming seawater;
c) Pressurization for the injection into the high salinity area 11 of the osmosis chamber 1;
d) Osmosis in the osmosis chamber;
e) Converting the water pressure into motion by the pressure-motion converter 2;
f) Ship propulsion;
g) Heating the salt water by the heater (preferably heat exchanger);
h) Evaporation of the salt water into the evaporation chamber 32;
i) Cooling and condensing the water steam in the condensation chamber;
j) Collection of fresh water and introduction of the fresh water into the low salinity area 12 of the osmosis chamber 1;
k) Salt production;
l) Salt storage;
m) Excess salt goes back into the sea;
n) Conducting the excess steam pressure from the evaporation chamber 32 to the steam turbine;
o) Generation of electrical energy by the steam turbine;
p) Expulsion of steam through a chimney;
q) Production of electrical energy by solar cells or wind turbines or heat generation by solar collectors;
r) Heating;
s) Surplus electricity from solar cells or wind turbines is used to electrolyze fresh water;
t) Production of oxygen through the electrolysis of fresh water;
u) Production of hydrogen through the electrolysis of fresh water;
v) Fuel cell to generate electricity to compensate for a power shortage.

1. Environmentally friendly ship propulsion system comprising an osmosis chamber (1), a pressure relief unit (2) and a desalination unit, wherein:
the osmosis chamber (1) comprises a high salinity region (11) and a low salinity region (12) which are separated from one another by an osmotic membrane (13),
the pressure relief unit (2) has at least one pressure-motion converter which is connected via a high-pressure line (21) to the high salinity region (11) of the osmosis chamber (1),
the desalination unit is adapted to produce, from salt water, on the one hand, salt or at least high-salinity water and on the other hand, fresh water or at least low-salinity water,
a fresh water pipe connects the desalination unit with the low salinity area (12) of the osmosis chamber (1) and a salt water supply (14) is controllably connected to the high salinity area (11) of the osmosis chamber (1).

2. Environmentally friendly ship propulsion system according to claim 1, characterized in that the osmotic membrane (13) on the side of the low salinity region (12) is provided with a porous ceramic (15) which has continuous capillary channels (153).

3. Environmentally friendly ship propulsion according to claim 2, characterized in that the porous ceramic (15) is in the form of tubes which are coated with the osmotic membrane (13), and the osmosis chamber (1) is in the form of a tank through which the ceramic tubes pass, wherein the tank forms the high salinity area (11) and the inner volume of the ceramic tubes forms the low salinity area (12).

4. Environmentally friendly ship propulsion according to claim 2, characterized in that the pressure relief unit (2) comprises two cylinders (23a, 23b), each with a first piston (24a, 24b), which are arranged along the same longitudinal axis, wherein:
the two first pistons (24a, 24_{b}) are connected to one another in such a way that they can be moved together and are always at the same distance from one another,
the area of each cylinder (23a, 23b) facing the other cylinder (23a, 23b) forms a front chamber (25a, 25b) which is defined by the first piston (24a, 24b), the lateral walls of the cylinder (23a, 23b) and an immovable end wall (26) of the cylinder (23a, 23b),
on the other side of each cylinder (23a, 23b) there is a rear chamber (27a, 27b), which is delimited by the first piston (24a, 24b), lateral walls and an end face of a second piston (281),
the second piston (281) is connected by a connecting rod (282) to a crankshaft (283), which is used to propel the ship,
the rear chambers (27a, 27b) are spatially separated from the front chambers (25a, 25b) to avoid any mixing of the liquids located therein.

5. Environmentally friendly ship propulsion according to claim 1, characterized in that the desalination unit comprises an evaporation chamber (32) which is substantially cylindrical and comprises a plurality of atomization nozzles (321), the atomization nozzles (321) being arranged in such a way that they can generate a vortex in the evaporation chamber (32).

6. Environmentally friendly ship propulsion according to claim 1, characterized in that the desalination unit comprises an evaporation chamber (32) with a plurality of misting nozzles (321), wherein a misting nozzle (321) has a central salt water channel (3211) for salt water (SW), a first concentric air channel (3212) for hot air (HL1) and a second concentric air channel (3213) for hot air (HL2), the middle salt water duct (3211) forming the longitudinal central axis of the misting nozzle (321) and being surrounded by the first concentric air channel (3212), which itself is surrounded by the second concentric air channel (3212), and wherein the concentric air channels (3212, 3213) are frustoconical and converge to the longitudinal central axis of the misting nozzle (321).

7. Environmentally friendly ship propulsion according to claim 1, characterized in that the desalination unit comprises an evaporation chamber (32), a condensation chamber and a heater, the condensation chamber being a heat exchanger for transferring the thermal energy of the incoming water steam and of the warm condensed fresh water to the salt water entering the desalination unit.

8. Method for propelling a ship with an osmosis chamber (1) comprising a high salinity region (11) and a low salinity region (12), which are separated from one another by an osmotic membrane (13), characterized by the following method steps:
Suction of salt water from the environment and introduction into the high salinity area (11);
Pressure increase in the high salinity area (11) due to osmosis through the osmotic membrane (13);
Generating energy to propel the ship by relieving the pressure prevailing in the high salinity area (11);
Production of low salinity water by desalination of salt water;
Introduction of low salinity water into the low salinity area (12).

9. Method according to claim 8, wherein low salinity water is produced by desalination of the salt water emerging from the high salinity area (11).

10. Method according to claim 8, wherein salt or high-salinity water is produced by desalination of salt water, wherein the salt or high-salinity water is mixed with the salt water entering the high-salinity region (11).
